(19) United States
(12) Patent Application Publication
(10) Pub. No.: US 2018/0004527 A1
(43) Pub. Date: Jan. 4, 2018

(54) OPERATION OF A MULTI-SLICE PROCESSOR IMPLEMENTING PRIORITIZED DEPENDENCY CHAIN RESOLUTION

(71) Applicant: International Business Machines Corporation, ARMONK, NY (US)

(72) Inventors: KHANDKER N. ADEEB, AUSTIN, TX (US); JOSHUA W. BOWMAN, AUSTIN, TX (US); BRANDON R. GODDARD, FRIENDSWOOD, TX (US); DUNG Q. NGUYEN, AUSTIN, TX (US); TU-AN T. NGUYEN, AUSTIN, TX (US); EULA A. TOLENTINO, AUSTIN, TX (US); BRIAN D. VICTOR, AUSTIN, TX (US); BRENDAN M. WONG, BEAUMONT, TX (US)

(21) Appl. No.: 15/198,699

(22) Filed: Jun. 30, 2016

(51) Int. Cl. G06F 9/38; G06F 9/30

(52) U.S. Cl. CPC G06F 9/3802; G06F 9/3836; G06F 9/3016; G06F 9/30021; G06F 9/30058; G06F 9/30072

(57) ABSTRACT

Operation of a computer processor that includes: receiving a first instruction indicating a first target register; receiving, from an instruction fetch unit of the computer processor, a first instruction and a branch instruction; responsive to determining that the branch instruction is dependent upon a result of the first instruction, updating a priority value corresponding to the first instruction; and issuing, in dependence upon the priority value for the first instruction having a higher priority than a priority value for another instruction, the first instruction to an execution unit of the computer processor.

### BACKGROUND

### Field of the Invention

The field of the invention is data processing, or, more specifically, methods and apparatus for operation of a multi-slice processor.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One area of computer system technology that has advanced is computer processors. As the number of computer systems in data centers and the number of mobile computing devices has increased, the need for more efficient computer processors has also increased. Speed of operation and power consumption are just two areas of computer processor technology that affect efficiency of computer processors.

### SUMMARY

Methods and apparatus for operation of a multi-slice processor are disclosed in this specification. Such a multi-slice processor includes a plurality of execution slices and a plurality of load/store slices, where the load/store slices are coupled to the execution slices via a results bus. Operation of such a multi-slice processor includes: receiving a first instruction indicating a first target register; receiving, from an instruction fetch unit of the computer processor, a first instruction and a branch instruction; responsive to determining that the branch instruction is dependent upon a result of the first instruction, updating a priority value corresponding to the first instruction; and issuing, in dependence upon the priority value for the first instruction having a higher priority than a priority value for another instruction, the first instruction to an execution unit of the computer processor.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for operation of a multi-slice processor according to embodiments of the present invention.

FIG. 2 sets forth a block diagram of a portion of a multi-slice processor according to embodiments of the present invention.

FIG. 3 sets forth a block diagram of an instruction sequencing unit of a multi-slice processor, where the instruction sequencing unit is configured to implement prioritized dependency chain resolution to improve branch misprediction penalties according to different embodiments.

FIG. 4 sets forth a flow chart illustrating an exemplary method of implementing prioritized dependency chain resolution to improve branch misprediction penalties according to different embodiments.

FIG. 5 sets forth a flow chart illustrating an exemplary method of operation of a multi-slice processor configured to implement prioritized dependency chain resolution to improve branch misprediction penalties according to different embodiments.

FIG. 6 sets forth a flow chart illustrating an exemplary method of operation of a multi-slice processor configured to implement prioritized dependency chain resolution to improve branch misprediction penalties according to different embodiments.

### DETAILED DESCRIPTION

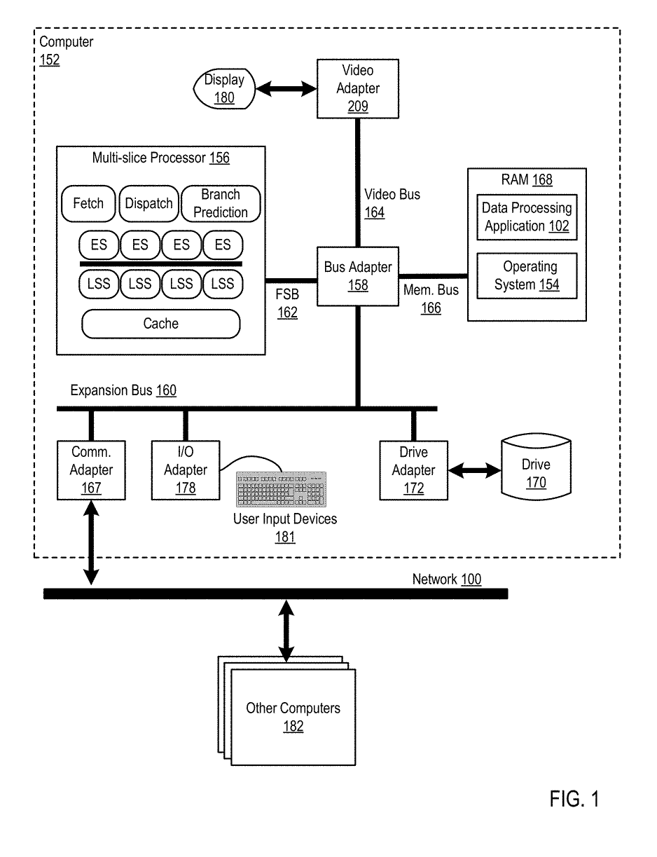

Exemplary methods and apparatus for operation of a multi-slice processor in accordance with the present invention are described with reference to the accompanying drawings, beginning with FIG. 1. FIG. 1 sets forth a block diagram of an example system configured for operation of a multi-slice processor according to embodiments of the present invention. The system of FIG. 1 includes an example of automated computing machinery in the form of a computer (152).

The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

The example computer processor (156) of FIG. 1 may be implemented as a multi-slice processor. The term ‘multi-slice’ as used in this specification refers to a processor having a plurality of similar or identical sets of components, where each set may operate independently of all the other sets or in concert with the one or more of the other sets. The multi-slice processor (156) of FIG. 1, for example, includes several execution slices (‘ES’) and several load/store slices (‘LSS’)—where load/store slices may generally be referred to as load/store units. Each execution slice may be configured to provide components that support execution of instructions: an issue queue, general purpose registers, a history buffer, an arithmetic logic unit (including a vector scalar unit, a floating point unit, and others), and the like. Each of the load/store slices may be configured with components that support data movement operations such as loading of data from cache or memory or storing data in cache or memory. In some embodiments, each of the load/store slices includes a data cache. The load/store slices are coupled to the execution slices through a results bus. In some embodiments, each execution slice may be associated with a single load/store slice to form a single processor slice. In some embodiments, multiple processor slices may be configured to operate together.

The example multi-slice processor (156) of FIG. 1 may also include, in addition to the execution and load/store slices, other processor components. In the system of FIG. 1, the multi-slice processor (156) includes fetch logic, dispatch logic, and branch prediction logic. Further, although in some embodiments each load/store slice includes cache memory, the multi-slice processor (156) may also include cache accessible by any or all of the processor slices.

Although the multi-slice processor (156) in the example of FIG. 1 is shown to be coupled to RAM (168) through a front side bus (162), a bus adapter (158) and a high speed memory bus (166), readers of skill in the art will recognize that such configuration is only an example implementation. In fact, the multi-slice processor (156) may be coupled to other components of a computer system in a variety of configurations. For example, the multi-slice processor (156) in some embodiments may include a memory controller configured for direct coupling to a memory bus (166). In some embodiments, the multi-slice processor (156) may support direct peripheral connections, such as PCIe connections and the like.

Stored in RAM (168) in the example computer (152) is a data processing application (102), a module of computer program instructions that when executed by the multi-slice processor (156) may provide any number of data processing tasks. Examples of such data processing applications may include a word processing application, a spreadsheet application, a database management application, a media library application, a web server application, and so on as will occur to readers of skill in the art. Also stored in RAM (168) is an operating system (154). Operating systems useful in computers configured for operation of a multi-slice processor according to embodiments of the present invention include UNIX™, Linux™, Microsoft Windows™, AIX™, IBM's z/OS™, and others as will occur to those of skill in the art. The operating system (154) and data processing application (102) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers configured for operation of a multi-slice processor according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for operation of a multi-slice processor according to embodiments of the present invention include modems for wired dial-up communications, Ethernet (IEEE 802.3) adapters for wired data communications, and 802.11 adapters for wireless data communications.

The arrangement of computers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

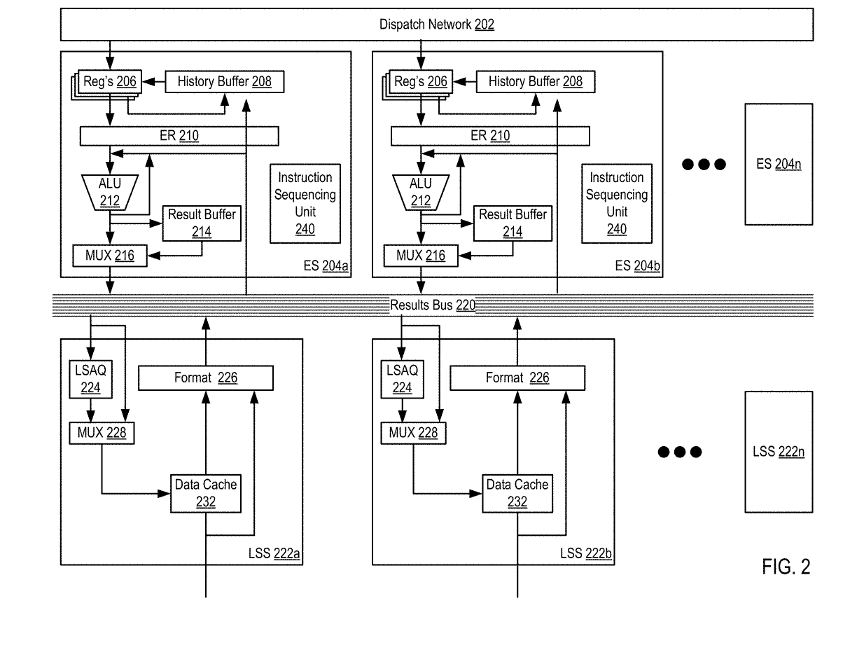

For further explanation, FIG. 2 sets forth a block diagram of a portion of a multi-slice processor according to embodiments of the present invention. The multi-slice processor in the example of FIG. 2 includes a dispatch network (202). The dispatch network (202) includes logic configured to dispatch instructions for execution among execution slices.

The multi-slice processor in the example of FIG. 2 also includes a number of execution slices (204a, 204b-204n). Each execution slice includes general purpose registers (206) and a history buffer (208). The general purpose registers and history buffer may sometimes be referred to as the mapping facility, as the registers are utilized for register renaming and support logical registers.

The general purpose registers (206) are configured to store the youngest instruction targeting a particular logical register and the result of the execution of the instruction. A logical register is an abstraction of a physical register that enables out-of-order execution of instructions that target the same logical register.

When a younger instruction targeting the same particular logical register is received, the entry in the general purpose register is moved to the history buffer, and the entry in the general purpose register is replaced by the younger instruction. The history buffer (208) may be configured to store many instructions targeting the same logical register. That is, the general purpose register is generally configured to store a single, youngest instruction for each logical register while the history buffer may store many, non-youngest instructions for each logical register.

Each execution slice (204) of the multi-slice processor of FIG. 2 also includes an execution reservation station (210). The execution reservation station (210) may be configured to issue instructions for execution. The execution reservation station (210) may include an issue queue. The issue queue may include an entry for each operand of an instruction. The issue queue may also include a single entry per single instruction, where the single entry handles all operands for the single instruction. The execution reservation station may issue a complete instruction at a time, including the operands for the instruction when the operands for the instruction are ready, for execution—depending on whether the instruction is a load/store instruction or an arithmetic instruction—by the arithmetic logic unit (ALU) (212) or to a load/store slice (222a, 222b, 222c) via the results bus (220). For example, the execution reservation station may determine that data for all operands is available, and in response, the execution reservation station may issue the instruction to the arithmetic logic unit (212).

The arithmetic logic unit (212) depicted in the example of FIG. 2 may be composed of many components, such as add logic, multiply logic, floating point units, vector/scalar units, and so on. Once an arithmetic logic unit executes an operand, the result of the execution may be stored in the result buffer (214) or provided on the results bus (220) through a multiplexer (216).

The results bus (220) may be configured in a variety of manners and be of composed in a variety of sizes. In some instances, each execution slice may be configured to provide results on a single bus line of the results bus (220). In a similar manner, each load/store slice may be configured to provide results on a single bus line of the results bus (220). In such a configuration, a multi-slice processor with four processor slices may have a results bus with eight bus lines—four bus lines assigned to each of the four load/store slices and four bus lines assigned to each of the four execution slices. Each of the execution slices may be configured to snoop results on any of the bus lines of the results bus. In some embodiments, any instruction may be dispatched to a particular execution unit and then be issued to any other slice for performance benefits. Further, an instruction may also be executed by a different execution slice than the execution slice from which the instruction is issued. As such, any of the execution slices may be coupled to all of the bus lines to receive results from any other slice. Further, each load/store slice may be coupled to each bus line in order to receive an issue load/store instruction from any of the execution slices. Readers of skill in the art will recognize that many different configurations of the results bus may be implemented.

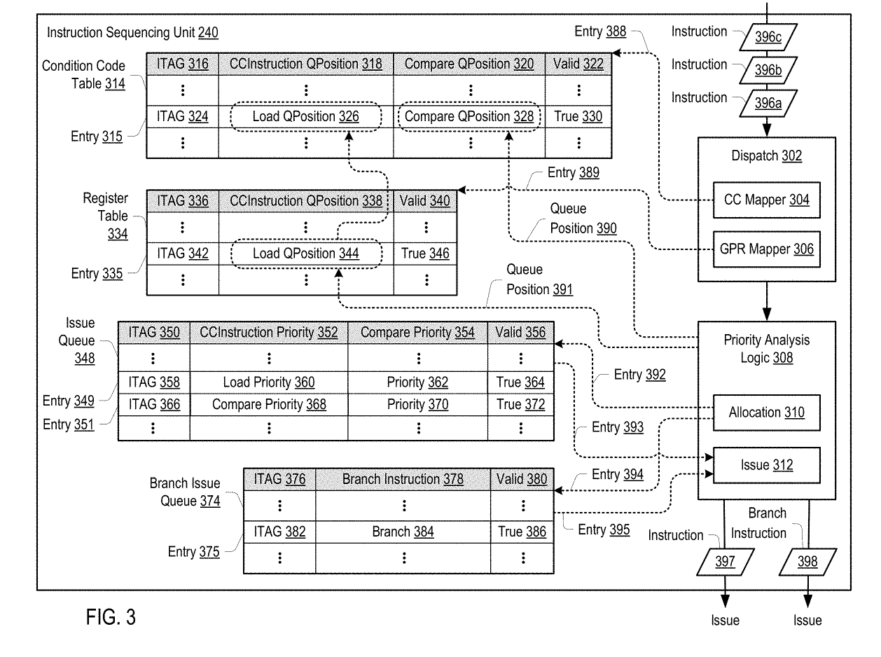

The multi-slice processor in the example of FIG. 2 also includes a number of load/store slices (222a, 222b-222n). Each load/store slice includes a load/store access queue (LSAQ) (224), a multiplexer (MUX) (228), a data cache (232), and formatting logic (226), among other components described below with regard to FIG. 3. The load/store access queue (224) receives load and store operations to be carried out by the load/store slice (222). The formatting logic (226) formats data into a form that may be returned on the results bus (220) to an execution slice as a result of a load or store instruction. The multiplexer (228) may select an input in dependence upon data from the load/store access queue (224) or on receiving data from the results bus.

The example multi-slice processor of FIG. 2 may be configured for flush and recovery operations. A flush and recovery operation is an operation in which the registers (general purpose register and history buffer) of the multi-slice processor are effectively ‘rolled back’ to a previous state. The term ‘restore’ and ‘recover’ may be used, as context requires in this specification, as synonyms. Flush and recovery operations may be carried out for many reasons, including branch mispredictions, exceptions, and the like. Consider, as an example of a typical flush and recovery operation, that a dispatcher of the multi-slice processor dispatches over time and in the following order: an instruction A targeting logical register 5, an instruction B targeting logical register 5, and an instruction C targeting logical register 5. At the time instruction A is dispatched, the instruction parameters are stored in the general purpose register entry for logical register 5. Then, when instruction B is dispatched, instruction A is evicted to the history buffer (all instruction parameters are copied to the history buffer, including the logical register and the identification of instruction B as the evictor of instruction A), and the parameters of instruction B are stored in the general purpose register entry for logical register 5. When instruction C is dispatched, instruction B is evicted to the history buffer and the parameters of instruction C are stored in the general purpose register entry for logical register 5. Consider, now, that a flush and recovery operation of the registers is issued in which the dispatch issues a flush identifier matching the identifier of instruction C. In such an example, flush and recovery includes discarding the parameters of instruction C in the general purpose register entry for logical register 5 and moving the parameters of instruction B from the history buffer for instruction B back into the entry of general purpose register for logical register 5. In other words, in this example, instruction B is moved back into the entry of the general purpose register for logical register 5 instead of instruction A because instruction B was not flushed. However, in this example, if instruction C and instruction B been flushed, then instruction A would have been selected to be moved back to the history buffer.

During the flush and recovery operation, in prior art processors, the dispatcher was configured to halt dispatch of new instructions to an execution slice. Such instructions may be considered either target or source instructions. A target instruction is an instruction that targets a logical register for storage of result data. A source instruction by contrast has, as its source, a logical register. A target instruction, when executed, will result in data stored in an entry of a register file while a source instruction utilizes such data as a source for executing the instruction. A source instruction, while utilizing one or more logical registers as its source, may also target another one or more logical registers for storage of the results of instruction. That is, with respect to one logical register, an instruction may be considered a source instruction and with respect to another logical register, the same instruction may be considered a target instruction.

The multi-slice processor in the example of FIG. 2 also includes an instruction sequencing unit (240). While depicted within individual execution slices, in some cases, the instruction sequencing unit may be implemented independently of the execution slices or implemented within dispatch network (202). Instruction sequencing unit (240) may take dispatched instructions and check dependencies of the instructions to determine whether all older instructions with respect to a current instruction have delivered, or may predictably soon deliver, results of these older instructions from which the current instruction is dependent so that the current instruction may execute correctly. If all dependencies to a current instruction are satisfied, then a current instruction may be determined to be ready to issue, and may consequently be issued—regardless of a program order of instructions, where a program order may be determined by an instruction tag (ITAG). Such issuance of instructions may be referred to as an “out-of-order” execution, and the multi-slice processor may be considered an out-of-order machine.

In some cases, a load/store unit receiving an issued instruction, such as a load/store slice, may not yet be able to handle the instruction, and the instruction sequencing unit (240) may keep the instruction queued until such time as the load/store slice may handle the instruction. After the instruction is issued, the instruction sequencing unit (240) may track progress of the instruction based at least in part on signals received from a load/store slice.

For further explanation, FIG. 3 sets forth a block diagram depicting an instruction sequencing unit (240) configured to include logic for implementing prioritized dependency chain resolution to improve branch misprediction penalties. Prioritized dependency chain resolution allows for issuance of instructions such that a dependency chain of one or more instructions on which a branch instruction is dependent is determined to have a higher issuance priority which may result in branch instructions being evaluated earlier, which may result in a reduction in instructions being flushed, thereby reducing branch misprediction penalties. Instructions on which a branch instruction may be dependent may include instructions that generate results into general purpose registers or condition code registers that may be used by the branch instruction to determine whether or not to branch.

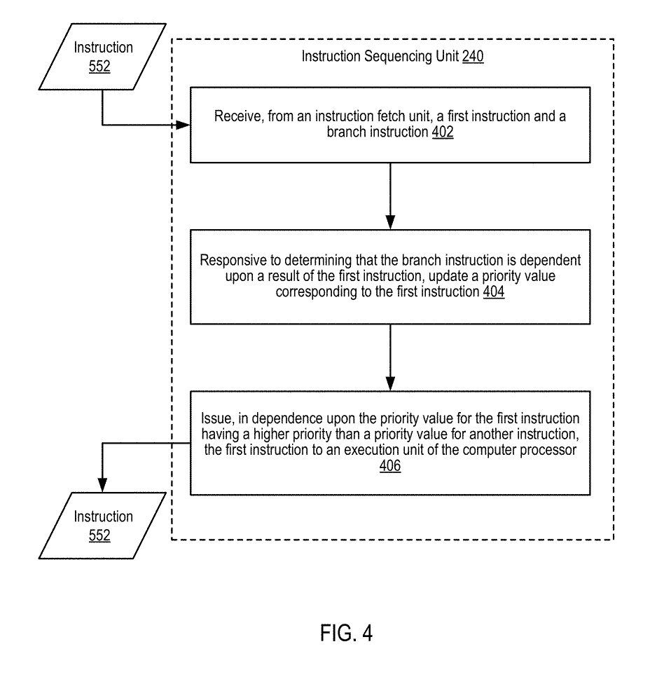

The instruction sequencing unit (240) may include a dispatch (302) unit and priority analysis logic (308), where the dispatch (302) unit may include a condition code (CC) mapper (304) and a general purpose register (GPR) mapper (306), and where the priority analysis logic (308) may include allocation (310) logic and issue (312) logic. While the logical units depicted in FIG. 4 are organized hierarchically in this example, in other examples, the arrangement of logical units may be different.

Further, the instruction sequencing unit (240) may maintain state information usable to track received instructions until issuance, including information about other instructions being maintained. For example, the instruction sequencing unit (240) may maintain a condition code table (314), a register table (334), an issue queue (348), and a branch issue queue (374) to store instruction information for implementing prioritized dependency chain resolution to improve branch misprediction penalties.

The condition code table (314) may store entries—corresponding to condition code registers—where an entry may store information for an instruction that results in a modification to a condition code, or condition codes, of a particular condition code register. The entries may correspond to instructions in a dependency chain for a branch instructions, and such a dependency chain may be determined in response to receiving a branch instructions and decoding the branch instruction to determine dependencies. A condition code register may store indications of a particular condition code state, such as a condition code to reflect a zero result of an instruction, a negative value result of an instruction, or one or more error results for an execution unit, or one or more results or errors for a load/store slice operation, among other possible condition codes.

The condition code table (314) may store, for an instruction modifying a condition code register, an ITAG (316) field, a condition code instruction queue position (“CCInstruction QPosition”) (318) field, a compare instruction queue position (“Compare QPosition”) (320) field, and a valid (322) field. The ITAG (316) field may store a value for the ITAG of an instruction, such as a compare instruction, where the instruction may set a condition code for a condition code register, and where the instruction information is stored in an entry of the issue queue (348). The condition code instruction queue position (318) field may store a value for the queue position of a previous instruction, where the queue position indicates an entry of the issue queue (348), and where the previous instruction is an instruction on which the instruction corresponding to the entry in the condition code table (314), is dependent, such as a load instruction, an addition instruction, or some other instruction. The compare instruction queue position (320) field, as noted earlier, may store a queue position, or a value indicating an entry, within the issue queue (348) for an instruction corresponding to the entry created for the instruction in the condition code table (314)—this index information into the issue queue (348) may allow the instruction sequencing unit (240) to avoid a compare operation of all ITAGS in the issue queue (348) to identify the instruction in the issue queue (348) that corresponds to the instruction in the condition code table (314) at a time when the instruction in the condition code table (314) is determined to be part of a dependency chain for a branch instruction. In other examples, instructions other than a compare instruction may be in the dependency chain and tracked. The valid (322) field may store an indication of validity or invalidity, which may be set or cleared dependent on various conditions, including issuance of an instruction or an instruction being flushed.

The register table (334) may store—for an instruction modifying a general purpose register—an ITAG (336) field, a condition code instruction queue position (“CCInstruction QPosition”) (338) field, and a valid (340) field. The entries may correspond to instructions in a dependency chain for a branch instructions, and such a dependency chain may be determined in response to receiving a branch instructions and decoding the branch instruction to determine dependencies. The ITAG (336) field may store a value for an ITAG of a particular instruction that modifies a general purpose register. As noted above with regard to the condition code table (314), the particular instruction entry in the register table (334) may be an instruction on which an instruction entry in the condition code table (314) may be dependent. In other words, the particular instruction may generate a result usable by the instruction in the condition code table (314). The condition code instruction queue position (338) field may store a queue position, or a value indicating an entry, within the issue queue (348) for an instruction entry of the register table (334). The valid (322) field may store an indication of validity or invalidity, which may be set or cleared dependent on various conditions, including issuance of an instruction or an instruction being flushed.

The issue queue (348) may store—for every instruction that is not a branch instruction—an ITAG (350) field, a condition code instruction priority (352) value, a compare instruction priority (354) value, a valid (356) field, among other possible fields. As noted above, the issue queue (348) may maintain instruction information for received instructions that have not yet issued. The ITAG (350) field may store an ITAG value that identifies and corresponds to a particular instruction received from an instruction fetch unit. The condition code instruction priority (352) field may store a value that indicates a priority for an instruction entry in the register table (334) on which a compare instruction entry in the condition code table (314) is dependent—where the condition code instruction priority value may be considered as a basis for the issue logic in determining a next instruction to issue from among a plurality of ready instructions. The compare instruction priority (354) field may store a value that indicates a priority for a compare instruction—where the compare instruction priority value may be considered as a basis for the issue logic in determining a next instruction to issue from among a plurality of ready instructions. The valid (322) field may store an indication of validity or invalidity, which may be set or cleared dependent on various conditions, including issuance of an instruction or an instruction being flushed.

The branch issue queue (374) may store—for every branch instruction—an ITAG (376) field, branch instruction (378) information, a valid (380) field, among other possible fields. Further, the branch issue queue (374) may maintain instruction information received instruction that has not yet issued. The ITAG (350) field may store an ITAG value that identifies and corresponds to a particular branch instruction received from an instruction fetch unit. The branch instruction (378) information field may store control fields, or other instruction related information, usable in issuing a branch instruction. The valid (322) field may store an indication of validity or invalidity, which may be set or cleared dependent on various conditions, including issuance of an instruction or an instruction being flushed.

While in this example, the issue queue (348) and the branch issue queue (374) are depicted as separate structures, in other examples, the issue queue (348) and the branch issue queue (374) may be combined. Similarly, in other examples, there may be additional queues for different types of instructions. However, in each example arrangement of issue queues, the functionality, for the logic implementing prioritized dependency chain resolution to improve branch misprediction penalties, remains.

As an example of prioritized dependency chain resolution, the dispatch (302) unit may receive three instructions, instructions (396a, 396b, 396c), where instruction (396a) is a load instruction, instruction (396b) is a compare instruction, and instruction (396c) is a branch instruction. Further, the load instruction (396a) is received first, the compare instruction (396b) is received second, and the branch instruction (396c) is received third—where the load instruction loads into a register that is used by the compare instruction, and where the compare instruction sets a condition code in a condition code register that is used by the branch instruction to determine whether or not to branch. For the purposes of clarity, may be an initial computer instructions from a program listing. In other words, at a point in time when instruction (396) is received, the condition code table (314), the register table (334), the issue queue (348), and the branch issue queue (374) do not have any valid entries.

The dispatch (302) unit may analyze load instruction (396a) and determine that instruction (396a) is an instruction that modifies a general purpose register, and in response, the GPR mapper (306) may create an entry (335) by generating and propagating entry (389) information to the register table (334). For example, the register table (334) may maintain—for each general purpose register—an entry corresponding to a target register for the instruction. For example, if a load instruction is loading a value into register Rx, then entry (335) may correspond to Rx. In this example, load instruction (396a) may load a value from a memory location, and entry (335) may store the ITAG for the load instruction as ITAG (342) and store an indication of validity in the valid field, depicted as a true (346) value. In this example, the condition code instruction queue position (338) field is not populated until the load instruction (396a) is allocated an entry within the issue queue (348). In other examples, instruction (396a) may be any other instruction, for example, an arithmetic instruction that generates a result to be stored in a particular general purpose register—where the instruction (396a) may generate a result that may be used by a subsequent compare instruction.

The priority analysis logic (308) may receive the load instruction (396a) and, because instruction (396a) is not a branch instruction, create an entry within the issue queue (348). For example, allocation (310) logic may identify a location within the issue queue (348) for storing an entry corresponding to the instruction (396a). In this example, the allocation (310) logic may create an entry (349) by generating and propagating entry (392) information for the load instruction to the issue queue (348). For example, the ITAG (350) field may be set to the ITAG (358) value for the load instruction (396a), and the condition code instruction priority (352) field may be set to the load priority (360) value, which may be zero as an initial value, and the compare instruction priority (354) field may be set to a priority (362) value, which may be zero as an initial value, and the valid (340) field may be set to true (346), which may indicate valid. As noted above, if the load instruction in entry (349) is later determined to be an instruction on which a subsequent branch instruction is dependent, the (352) and (354) values may be updated to indicate a higher priority value.

Further, the dispatch (302) unit may receive another instruction (396b), and in this example, instruction (396b) may be a compare instruction. The dispatch (302) unit may determine that the instruction (396b) modifies a condition code register, and in response the CC mapper (304) may create an entry (315) by generating and propagating entry (388) information to the condition code table (314). For example, the condition code table (314) may maintain for each condition code register—an entry corresponding to a condition code register for the instruction. For example, if the compare instruction is comparing a register value to zero, and the condition code flag is set within condition code register Rx, then entry (315) may correspond to condition code register Rx—where the condition code flag indicates whether or not the register value is zero. In this example, the ITAG (316) field may be set to the ITAG (324) value for the compare instruction (396b), and the condition code instruction queue position (318) field may be set to load queue position (“Load QPosition”) (326)—where the dispatch (302) logic may set the load queue position (326) value in dependence upon determining that the compare instruction (396b) depends upon a register Rx, and that an entry in the register table (334) includes a valid entry for an instruction that modifies the register Rx. In other words, the dispatch (302) logic determines that the load instruction (396a) is an instruction which generates a result into a register which is used by the compare instruction (396b). Further, the compare instruction queue position (320) field may be set to the issue queue (348) queue position for the compare instruction (396) when the compare instruction is allocated within the issue queue (348), and the valid (322) field may be set to true (330), which may indicate valid. In this example, the condition code instruction queue position (326) may be copied from the register table (334) because the register table (334) also stores the queue position for the load instruction (396a) within the issue queue (348)—in this example, load queue position (344), which corresponds to issue queue (348) entry (349). Transmission of the load queue position (344) value is depicted by queue position (391) data from the priority analysis logic (308). Transmission of the entry (349) data from the priority analysis logic (308) is depicted by entry (392).

The priority analysis logic (308) may receive compare instruction (396b) and, because the compare instruction (396b) is not a branch instruction, create an entry within the issue queue (348). For example, allocation (310) logic may identify a location within the issue queue (348) for storing an entry corresponding to the compare instruction (396b). In this example, the allocation logic may create an entry (351) by generating and propagating entry (392) information for the compare instruction (396b) to the issue queue (348). Further, the ITAG (350) field may be set to the ITAG (366) value for the compare instruction (396b), and the condition code instruction priority (352) field may be set to the compare priority (368) value, which may be zero as an initial value, and the compare instruction priority (354) field may be set to a priority (370) value, which may be zero as an initial value, and the valid (340) field may be set to true (372), which may indicate valid. As noted above, if the compare instruction in entry (351) is later determined to be an instruction on which a subsequent branch instruction is dependent, the (352) and (354) values may be updated to indicate a higher priority value. Transmission of the entry (351) data from the priority analysis logic (308) is depicted by entry (392).

Further, in this example, the dispatch (302) unit may receive instruction (396c), and in this example, instruction (396c) may be a branch instruction that branches if a condition code indicates a result of a comparison has set a condition code flag to a particular value, such as zero. The dispatch (302) unit may determine that the instruction (396c) is a branch instruction, and in response, identifies a condition code register on which the branch instruction (396) is dependent, and in dependence upon the identified condition code register, the dispatch (302) logic may determine a valid instruction entry in the condition code table (314) corresponding to the identified condition code register. In this way, the dispatch (302) logic may determine one or more instructions on which the branch instruction, instruction (396c) in this example, is dependent, so that the instructions on which the branch instruction (396) is dependent may have their respective, corresponding priority values in the issue queue (348) increased.

In this example, the branch instruction (396c) may be analyzed to determine that the branch condition is dependent upon a condition code register flag value, in response to determining the condition code register, the condition code table (314) may be indexed according to the condition code register to identify entry (315). Further, responsive to identifying the entry (315), corresponding to compare instruction upon which the branch instruction is dependent on for setting a condition code register flag, the issue queue (348) positions—for the compare instruction and load instruction within the dependency chain for the branch instruction—may be determined from the stored entry fields for the condition code instruction queue position (318) field and the compare instruction queue position (320) field values. In this example, the condition code instruction queue position (320) field value indicates that the load instruction (396a) is at issue queue position “Load QPosition” (326), corresponding to issue queue (348) entry (350), and the compare instruction queue position (320) field value indicates that the compare instruction (396b) is at issue queue position “Compare QPosition” (328), corresponding to issue queue (348) entry (351). Transmission of the “Compare QPosition” (328) value is depicted by queue position (390) data from the priority analysis logic (308).

In other words, responsive to identifying the load instruction queue position (326) value and the compare instruction queue position (328) values, the issue queue (348) may be indexed to identify both the load instruction entry (349) and the compare instruction (351) entry. Accessing, or reading, entry (349) and entry (351) by the priority analysis logic (308) is depicted by entry (393). In response to the load instruction entry (349) and the compare instruction (351) being instruction on which the branch instruction is dependent, the priority values for the entries for the load instruction entry (349) and the compare instruction (351) may be increased so that the issue (312) logic may use the priority values, among multiple instructions that may be ready to issue, to determine an order in which to issue ready instructions—where the order may correspond to a ranking of priority values for the multiple ready instruction.

In this example, the priority analysis logic (308) may then receive the instruction (396c) and, because the instruction (396c) is a branch instruction, create an entry within the branch issue queue (374). For example, allocation (310) logic may identify a location within the branch issue queue (348) for storing an entry corresponding to the branch instruction (396c). In this example, the allocation logic may create an entry (375) by generating and propagating entry (394) information for the branch instruction to the branch issue queue (375), and a branch instruction entry may be accessed, or read, by the priority analysis logic (308) as depicted by transmission of entry (395). For example, the ITAG (376) field may be set to the ITAG (382) value for the compare instruction (396), and the branch instruction (378) field value may be set to branch information (384) usable for issuing the branch instruction, and the valid (380) field value may be set to true (386), which may indicate valid. Further, non-branch instructions (397) may be issued to execution slices, and branch instructions (398) may be issued to branch execution units.

In this way, in response to receiving the branch instruction, the instructions on which the branch instruction is dependent on for making a decision with regard to branching or not branching may be prioritized over other instructions on which branch instruction is not dependent. In other words, instruction within a dependency chain of a branch instruction are prioritized over instructions that are not in the dependency chain of a branch instruction. Such prioritization of ready instructions within a dependency chain for a branch instruction may result in those instructions issuing sooner than other, lower priority ready instructions, which may result in quicker resolution of branch instructions, which may result in fewer penalties from mispredicted branches.

For further explanation, FIG. 4 sets forth a flow chart illustrating an exemplary method of implementing prioritized dependency chain resolution to improve branch misprediction penalties. In this example, instructions are received at an instruction sequencing unit (240) of a computer processor such as an execution slice (204) of a multi-slice processor (156). The method of FIG. 4 may be carried out by a multi-slice processor similar to that in the examples of FIGS. 1-4. Such a multi-slice processor may include an instruction sequencing unit (240) that includes a dispatch (302) unit, priority analysis logic (308), condition code table (314), register table (334), issue queue (348), and branch issue queue (374), as described above with regard to FIGS. 3 and 4.

The method of FIG. 4 includes receiving (402) instructions (552) from an instruction fetch unit, where the instructions include a first instruction and a branch instruction. Receiving (402) the first instruction and the branch instruction may be carried out by the instruction sequencing unit (240) receiving the first instruction and the second instruction from the dispatch network (202) along one of the data lines from the dispatch network (202) to an execution slice (204) depicted in FIG. 2. Further, respective instruction sequencing units (240) of the multiple execution slices may receive respective instructions from the dispatch network (202), where each instruction sequencing unit may implement dependency accumulation instruction sequencing.

The method of FIG. 4 also includes, responsive to determining that the branch instruction is dependent upon a result of the first instruction, updating (404) a priority value corresponding to the first instruction. Updating (404) the priority value corresponding to the first instruction may be carried out as described above with regard to the dispatch (302) unit in FIG. 3 receiving the branch instruction, determining a condition code register on which the branch instruction is dependent, and using the condition code register to index into the condition code table (314) to identify an entry for—in the referenced example—the compare instruction, and increasing a priority value for the compare instruction. Further, determining the condition code register is a may be carried out by decoding the branch instruction to identify the condition code register on which the branch instruction depends.

The method of FIG. 4 also includes, issuing (406), in dependence upon the priority value for the first instruction (552) having a higher priority than a priority value for another instruction, the first instruction (552) to an execution unit of the computer processor. Issuing (406) the first instruction (552) may be carried out by the issue (312) logic determining that the execution unit, or execution slice, may receiving another instruction to execute, and identifying—for example, using an age array indicating readiness for each queued instruction in the issue queue—multiple ready instructions, including, in this example, the first instruction (552) and the other instruction.

Issuing (406) the first instruction may be further carried out by the issue (312) logic indexing the issue queue (348) to identify stored priority values corresponding to entries for each of the ready instructions, and selecting the first instruction in dependence upon the first instruction having a higher priority value within the entry for the first instruction than the priority value for the entry for the other instruction, and issuing the first instruction to the execution unit.

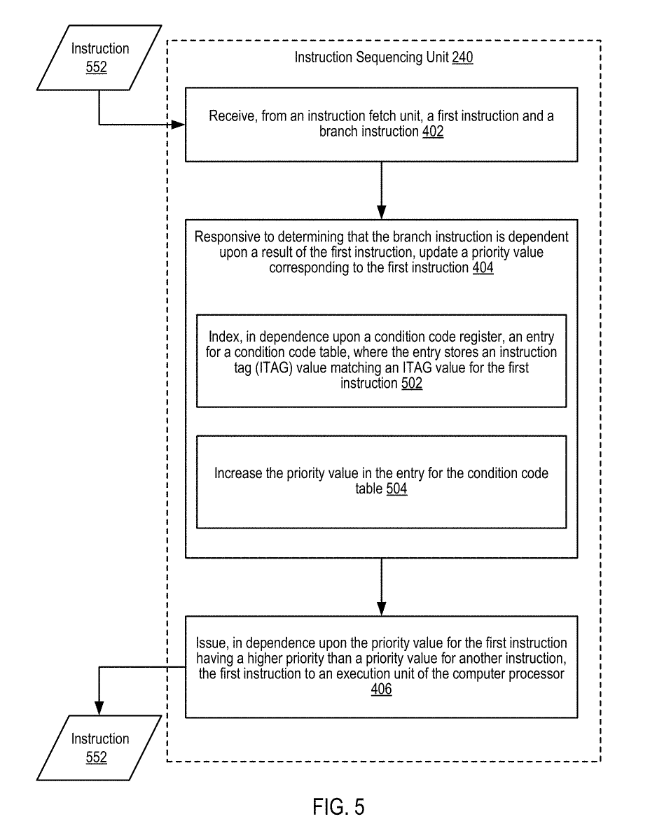

For further explanation, FIG. 5 sets forth a flow chart illustrating an exemplary method of implementing prioritized dependency chain resolution to improve branch misprediction penalties. In this example, instructions are received at an instruction sequencing unit (240) of a computer processor such as an execution slice (204) of a multi-slice processor (156). The method of FIG. 4 may be carried out by a multi-slice processor similar to that in the examples of FIGS. 1-4. Such a multi-slice processor may include an instruction sequencing unit (240) that includes a dispatch (302) unit, priority analysis logic (308), condition code table (314), register table (334), issue queue (348), and branch issue queue (374), as described above with regard to FIGS. 3 and 4.

The method of FIG. 5 is similar to the method of FIG. 4 in that the method of FIG. 5 also includes: receiving (402) instructions (552) from an instruction fetch unit, where the instructions include a first instruction and a branch instruction; responsive to determining that the branch instruction is dependent upon a result of the first instruction, updating (404) a priority value corresponding to the first instruction (552) ; and issuing (406), in dependence upon the priority value for the first instruction (552) having a higher priority than a priority value for another instruction, the first instruction (552) to an execution unit of the computer processor.

The method of FIG. 5 differs from the method of FIG. 4, however, in that the method of FIG. 5 further specifies updating (404) a priority value corresponding to the first instruction to include: indexing (502), in dependence upon a condition code register, an entry for a condition code table (314), where the entry stores an instruction tag (ITAG) value matching an ITAG value for the first instruction; and increasing (504) the priority value in the entry for the condition code table (314).

Indexing (502) an entry of the condition code register table (314) may be carried out by decoding the branch instruction to determine a condition code register upon which the branch instruction is dependent, where the condition code table (314) may be indexed according to the condition code register. Further, the entry in the condition code table (314) indexed by the condition code register may store within the condition code instruction queue position (318) field a value for indexing into the issue queue (348), and the entry may also store within the compare instruction queue position (320) field a value for indexing into the issue queue (348). The values, in fields (318) and (320), may be used to index entries in the issue queue (348), where the entries each have a compare instruction priority (352) value and a compare priority (354) value.

Increasing (504) the priority value in the entry—or multiple entries in the case where the dependency chain is more than a single instruction—for the condition code table may be carried out by, for example incrementing the priority values for each of the entries indexed in (502). In some examples, a default priority value may be set to zero, any value above zero may be considered to be higher priority.

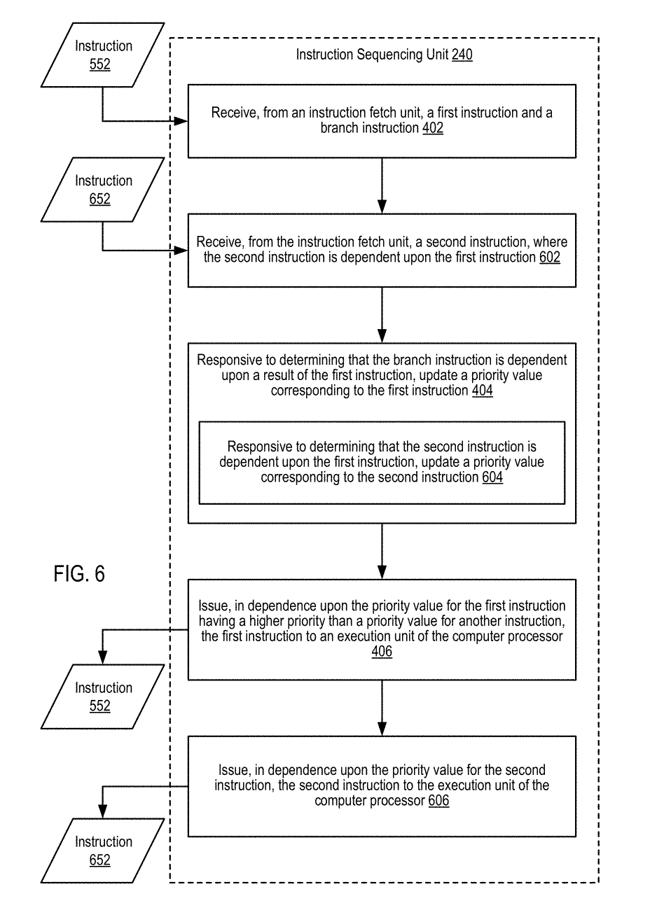

For further explanation, FIG. 6 sets forth a flow chart illustrating an exemplary method of implementing prioritized dependency chain resolution to improve branch misprediction penalties. In this example, instructions are received at an instruction sequencing unit (240) of a computer processor such as an execution slice (204) of a multi-slice processor (156). The method of FIG. 4 may be carried out by a multi-slice processor similar to that in the examples of FIGS. 1-4. Such a multi-slice processor may include an instruction sequencing unit (240) that includes a dispatch (302) unit, priority analysis logic (308), condition code table (314), register table (334), issue queue (348), and branch issue queue (374), as described above with regard to FIGS. 3 and 4.

The method is similar to the method of FIG. 4 in that the method of FIG. 5 also includes: receiving (402) instructions (552) from an instruction fetch unit, where the instructions include a first instruction and a branch instruction; responsive to determining that the branch instruction is dependent upon a result of the first instruction, updating (404) a priority value corresponding to the first instruction; and issuing (406), in dependence upon the priority value for the first instruction (552) having a higher priority than a priority value for another instruction, the first instruction (552) to an execution unit of the computer processor.

The method of FIG. 6 differs from the method of FIG. 4, however, in that the method of FIG. 6 further includes receiving (602), from the instruction fetch unit, a second instruction (652), where the second instruction is dependent upon the first instruction; includes, in further response to determining that the branch instruction is dependent upon the first instruction, responsive to determining that the second instruction is dependent upon the first instruction, updating a priority value corresponding to the second instruction; and issuing (606), in dependence upon the priority value for the second instruction, the second instruction to the execution unit of the computer processor.

Receiving (602) the second instruction (652) may be carried out similar to receiving (402) the first instruction described above with regard to FIG. 4.

Updating (604) the priority value corresponding to the second instruction may be carried out similar to updating (404) the priority value corresponding to the first instruction described above with regard to FIG. 4.

Issuing (606) the second instruction may be carried out similar to issuing (404) the priority value corresponding to the first instruction (552) described above with regard to FIG. 4.

In this way, in the case where there are multiple instructions in a dependency chain, each of the instructions in the dependency chain may be issued before other instructions of lower priority.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of operation of a computer processor, wherein the method comprises:
receiving, from an instruction fetch unit of the computer processor, a first instruction and a branch instruction;
responsive to determining that the branch instruction is dependent upon a result of the first instruction, updating a priority value corresponding to the first instruction; and
issuing, in dependence upon the priority value for the first instruction having a higher priority than a priority value for another instruction, the first instruction to an execution unit of the computer processor.

2. The method of claim 1, wherein issuing the first instruction is further dependent upon the first instruction being a ready instruction among a plurality of ready instructions.

3. The method of claim 2, wherein the first instruction is a compare instruction, and wherein execution of the compare instruction sets a condition code flag within a condition code register, and wherein the branch instruction determines whether to branch in dependence upon a value of the condition code flag of the condition code register.

4. The method of claim 3, wherein determining that the branch instruction is dependent upon the result of the first instruction comprises decoding the branch instruction to determine that the branch instruction depends upon the condition code flag of the condition code register.

5. The method of claim 4, wherein updating the priority value corresponding to the first instruction comprises:
indexing, in dependence upon the condition code register, an entry for a condition code table, wherein the entry stores an instruction tag (ITAG) value matching an ITAG value for the first instruction; and
increasing the priority value in the entry for the condition code table.

6. The method of claim 1, further comprising:
receiving, prior to receiving the branch instruction, a second instruction, wherein the second instruction is dependent upon the first instruction;
responsive to determining that the second instruction is dependent upon the first instruction, updating a priority value corresponding to the second instruction; and
issuing, in dependence upon the priority value for the second instruction, the second instruction to the execution unit of the computer processor.

7. The method of claim 1, wherein the first instruction is one of a plurality of instructions within a dependency chain, wherein the branch instruction is dependent upon each instruction in the dependency chain completing, and wherein responsive to determining that the branch instruction is dependent upon each of the instructions in the dependency chain, updating a respective priority value for each instruction in the dependency chain.

8. A computer processor configured to carry out:
receiving, from an instruction fetch unit of the computer processor, a first instruction and a branch instruction;
responsive to determining that the branch instruction is dependent upon a result of the first instruction, updating a priority value corresponding to the first instruction; and
issuing, in dependence upon the priority value for the first instruction having a higher priority than a priority value for another instruction, the first instruction to an execution unit of the computer processor.

9. The computer processor of claim 8, wherein issuing the first instruction is further dependent upon the first instruction being a ready instruction among a plurality of ready instructions.

10. The computer processor of claim 9, wherein the first instruction is a compare instruction, and wherein execution of the compare instruction sets a condition code flag within a condition code register, and wherein the branch instruction determines whether to branch in dependence upon a value of the condition code flag of the condition code register.

11. The computer processor of claim 10, wherein determining that the branch instruction is dependent upon the result of the first instruction comprises decoding the branch instruction to determine that the branch instruction depends upon the condition code flag of the condition code register.

12. The computer processor of claim 11, wherein updating the priority value corresponding to the first instruction comprises:
indexing, in dependence upon the condition code register, an entry for a condition code table, wherein the entry stores an instruction tag (ITAG) value matching an ITAG value for the first instruction; and
increasing the priority value in the entry for the condition code table.

13. The computer processor of claim 12, wherein computer processor is further configured to carry out:
receiving, prior to receiving the branch instruction, a second instruction, wherein the second instruction is dependent upon the first instruction;
responsive to determining that the second instruction is dependent upon the first instruction, updating a priority value corresponding to the second instruction; and
issuing, in dependence upon the priority value for the second instruction, the second instruction to the execution unit of the computer processor.

14. The multi-slice processor of claim 8, wherein the first instruction is one of a plurality of instructions within a dependency chain, wherein the branch instruction is dependent upon each instruction in the dependency chain completing, and wherein responsive to determining that the branch instruction is dependent upon each of the instructions in the dependency chain, updating a respective priority value for each instruction in the dependency chain.

15. An apparatus comprising:
a computer processor and an instruction sequencing unit, wherein the computer processor is configured to carry out:
receiving, from an instruction fetch unit of the computer processor, a first instruction and a branch instruction;
responsive to determining that the branch instruction is dependent upon a result of the first instruction, updating a priority value corresponding to the first instruction; and
issuing, in dependence upon the priority value for the first instruction having a higher priority than a priority value for another instruction, the first instruction to an execution unit of the computer processor.

16. The apparatus of claim 15, wherein issuing the first instruction is further dependent upon the first instruction being a ready instruction among a plurality of ready instructions.

17. The apparatus of claim 16, wherein the first instruction is a compare instruction, and wherein execution of the compare instruction sets a condition code flag within a condition code register, and wherein the branch instruction determines whether to branch in dependence upon a value of the condition code flag of the condition code register.

18. The apparatus of claim 17, wherein determining that the branch instruction is dependent upon the result of the first instruction comprises decoding the branch instruction to determine that the branch instruction depends upon the condition code flag of the condition code register.

19. The apparatus of claim 17, wherein updating the priority value corresponding to the first instruction comprises:
indexing, in dependence upon the condition code register, an entry for a condition code table, wherein the entry stores an instruction tag (ITAG) value matching an ITAG value for the first instruction; and
increasing the priority value in the entry for the condition code table.

20. The apparatus of claim 15, wherein the first instruction is one of a plurality of instructions within a dependency chain, wherein the branch instruction is dependent upon each instruction in the dependency chain completing, and wherein responsive to determining that the branch instruction is dependent upon each of the instructions in the dependency chain, updating a respective priority value for each instruction in the dependency chain.
